(19) United States
(12) Patent Application Publication
(10) Pub. No.: US 2024/0185184 A1
(43) Pub. Date: Jun. 6, 2024

(54) SYSTEM AND METHOD FOR CREATING EMPLOYEE BENEFIT BOOKLETS / GUIDES

(71) Applicant: JOE S. BLASCAK, IV, Waldo, OH (US)

(72) Inventor: JOE S. BLASCAK, IV, Waldo, OH (US)

(21) Appl. No.: 18/120,234

(22) Filed: Mar. 10, 2023

Related U.S. Application Data
(60) Provisional application No. 63/430,429, filed on Dec. 6, 2022.

(51) Int. Cl. G06Q 10/1057; G06F 3/0483; G06F 3/04845; G06F 3/0486; G06F 40/174; G06F 40/186; G06F 40/58

(52) U.S. Cl. CPC G06Q 10/1057; G06F 3/0483; G06F 3/04845; G06F 3/0486; G06F 40/174; G06F 40/186; G06F 40/58

(57) ABSTRACT

A system and method for creating an employee benefit booklet, mandatory annual legal notices, and compliance documents in five steps. The created booklets can be saved as templates and can be edited to create new employee benefit booklets for new clients, making the process quick and economical. Besides the booklet, compliance documents, election sheets, premium breakdown and the like documents can be created quickly with minimum data entry.

### CROSS-REFERENCE TO RELATED APPLICATIONS

This application claims priority from a U.S. provisional patent application Ser. No. 63/430,429 filed on Dec. 6, 2022, which is incorporated herein by reference in its entirety.

### FIELD OF INVENTION

The present invention relates to employee benefit booklets, and more particularly, the present invention relates to a system and method for creating employee benefit booklets.

### BACKGROUND

In most organizations, employees get certain benefits apart from basic compensation. Many of the benefits are mandatory for an organization to provide to its employees due to government regulations, while other benefits can be voluntary. The main objective of offering employee benefits is to promote the welfare of the employees. Secondarily, employers want to design the best possible benefit programs to attract and retain employees. The available benefits are many, however, key insurance benefits that are common in organizations include Medical, dental, vision, life, and Disability insurance.

In most instances, Insurance agencies and company HR departments are tasked with creating and managing the suite of plans a company offers their employees—this can, however, be a laborious, complex, and time-consuming process. On top of shopping the market for the best plans/rates, showcasing/consolidating the findings of these marketing efforts which can include 10-15 different insurance carriers/lines of coverage, completing the paperwork to set up the policies, holding the enrollment meetings for employees, and then manually/electronically loading coverage elections in the various insurance carrier systems, Insurance agencies/HR departments also need to provide all this insurance plan information to current and potential employees in an nice, neat, concise manner. This aids the current and potential employees in making an educated decision as to which lines of coverage and then which plans to elect based on their family's health and financial needs. To accomplish this, they create benefit booklets/guides. Without a definitive guide to outline the various coverage options, employees would only have access to a very high-level overview of offered benefits and they could make benefit elections that, due to the high and continually rising costs of healthcare, could put them into a very bad financial position. The Benefit booklet consists of a multitude of items—some of the main components are as follows: 1.) Information regarding eligibility—which employees and dependents are eligible to participate in the plan and when they are eligible, what happens when they terminate coverage, when plans changes are applicable during the year, etc. 2.) Insurance terms and definitions—defining the various insurance terms listed in the booklet and defining how to use certain documents provided within those lines of coverage. 3.) Detailed plan information for each and every plan offered—for example in a medical plan, there are hundreds of different provisions that can be defined which are commonly highlighted to help the employee assess their overall financial risk (individual deductible, family deductible, office visit copayment, specialist copayment, urgent care copayment, emergency room copayment, coinsurance level, outpatient surgery, inpatient surgery, prescription drug levels, major diagnostic levels, etc. and then all of these fields would have to be shown for out of network care as well). All of these benefit levels are listed for each medical plan offered, so if there were two, 3, or four or more plans, each of these benefit levels would be listed side by side so the employee can review and make an educated decision. Then, you would start completing the plan details for the other lines of coverage like dental, vision, life insurance, disability, accident, critical illness, cancer, hospital indemnity, etc. 4.) Contact information for the HR department, insurance agency representatives, insurance carrier customer service lines, insurance carrier websites, claims departments, etcetera . . . 5.) Employee payroll deductions/premiums—insurance rates are sold in monthly premiums via many different rating structures. For each insurance plan offered, these monthly premiums must go through a specific formula to create the actual employee payroll deduction amount. First, any employer contribution must be taken out, then the remaining amount must be broken down by the number of annual paychecks. This must be done for each insurance line of coverage and for each plan offered, within each rating type. 6.) Once these and many other provisions are loaded into the benefit booklet, Formatting, color schemes, logos and pictures are typically added to ensure the document is reader friendly and that it does not look like a lot of text simply strung together. Presenting a booklet to employees without any of these formatting provisions can make the document very hard to read and follow. Formatting can take an enormous amount of time and unfortunately, most insurance agencies and HR departments do not have the financial means available to hire marketing departments to help achieve these efforts. So, to aid in formatting they use common software, such as word processing software, spreadsheet programs, photo editing software, presentation software, and the like. Unfortunately, since insurance agents and HR departments do not specialize in marketing and graphic design, despite the hours and days it takes for them to produce these booklets, most of them are not very aesthetically pleasing, and in no way resemble the quality a marketing agency could provide. After this, if they have a need to provide this booklet in Spanish for any employees, they either must do so manually or pay a 3^{rd} party to handle the translation. For HR departments, they go through this process once a year for their company, and as is forementioned, this can take hours or days to complete; even if they have a set template they are using. For insurance agencies, this is a very different story-they typically have hundreds of clients and provide these documents for the vast majority of them. If you multiply the amount of time it takes to create one booklet each year by the hundreds of client's agencies build them for, the amount of time spent is staggering and exhausting—not to mention financially draining on small to mid-size Insurance agencies and HR departments.

Insurance Agencies/HR Departments are also tasked with providing government (Department of Labor and CMS) mandated annual legal notices and compliance documents (WRAP SPD, POP Document/Section 125 plan) to these employees in an easily accessible manner. The annual legal notices are typically provided In Word documents or PDF documents as templates. To complete these, an insurance agency or HR department have to comb through Multiple pages searching for applicable editable fields—for example: company name, company tax ID, specific plan provisions, company contact name/address/e-mail address, etc. This process is extremely tedious and can take hours to complete for one company—this is unfortunate as a lot of the required information in each document is repetitive. Compliance documents, such as the WRAP SPD and POP document, do not change much in their legal language from one company to another. Yet many third-party administrators charge companies and insurance agencies hundreds of dollars each year to generate them. This can get quite expensive, especially for insurance agencies who may want to provide these documents to hundreds of their clients.

Furthermore, Insurance agencies are mandated to provide a “Broker Compensation Disclosure Form” to any clients in which they earn over $1,000 in compensation in a given year. The template for this is typically in a Word document and while the majority of the information in the document stays the same, there are a handful of provisions that are specific to each of the agency's clients. As stated with the benefit booklets, annual legal notices, and compliance documents, creating these compensation disclosure forms for hundreds of clients every year can be tedious, exhausting and financially draining on the small to midsize insurance agency.

A need is therefore appreciated for a system and method that can assist in creating a professional looking benefit booklet (in English and Spanish) and easily keeping it updated (wherein many of the steps can be automated), as well as easily populating all applicable fields for mandatory annual legal notices, compliance documents and the broker compensation disclosure form.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method that can automate one or more steps in creating an employee benefits booklet, and populating annual legal notices, compliance documents and the broker compensation disclosure form.

It is another object of the present invention that the aforementioned benefit booklet, annual legal notices, compliance documents and broker compensation disclosure form, are completed in the system within five easy steps.

It is another object of the present invention that the time for making a booklet can be reduced significantly.

It is still another object of the present invention that the system and method can reduce the cost of making a booklet significantly.

It is yet another object of the present invention that the system and method can provide information about benefits in an organized manner reducing errors.

It is still a further object of the present invention that the booklet can have professional and aesthetic designs.

It is yet a further object of the present invention that the generated booklet can be translated to Spanish quickly and easily.

It is an additional object of the present invention that the system allows populating paper election sheets in the click of a button with no additional data entry, for those companies who choose to forego electronic open enrollment.

It is an additional object of the present invention that the system allows populating Premium breakdown sheet in the click of a button with no additional data entry.

It is an additional object of the present invention that the system allows keeping a library of all plan details that can be easily accessed to use with other clients eliminating reentry of same data.

It is an additional object of the present invention that allows using pre-loaded cover pages and themes, and the selected cover pages and themes can be changed instantly.

It is an additional object of the present invention that the system allows a user to change the color scheme of the entire booklet with the click of a button.

It is an additional object of the present invention that the users can add company logos as well as agency logos and have them placed professionally in the cover pages and back pages, respectively.

It is an additional object of the present invention that the booklets can be saved for editing later, changes can be made year over year.

It is an additional object of the present invention that the premium generator can calculate all “per paycheck” employee premiums from inputs including monthly premium, pay period and contribution.

It is an additional object of the present invention that the entire booklet can be saved as a template and be used to populate booklets for other companies within the system's portal.

It is an addition object of the present invention that the annual legal notices can be selected and populated with minimal data entry and no repetitive data entry.

It is an additional object of the present invention that external PDF content can be easily loaded as no two insurance agencies or HR departments showcase their benefits in the exact same manner. This feature is added so users can customize their booklet as they wish.

It is an additional object of the present invention that the objects in the booklet can be moved using “Drag and Drop” feature.

It is an additional object to the present invention that the finished booklets can be translated into Spanish in one click of a button.

It is an additional object to the present invention that users can create folders and up to three sub folders in Step 3 to save any PDF documents they wish to load into the system. This feature is made available so documents frequently used can be shared across multiple users without the need for importing them from your computer every time.

Features of the system are built to aid users so they can produce benefit booklets, legal notices, compliance documents and broker compensation disclosure forms all-in-one system with no redundant data entry, which will alleviate hours, if not days, spent creating these for a single company.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram illustrating the environment of the system, according to an exemplary embodiment of the present invention.

FIG. 2 is a block diagram illustrating the architecture of the system, according to an exemplary embodiment of the present invention.

FIG. 3 is a flow chart illustrating an implementation of the booklet module, according to an exemplary embodiment of the present invention.

FIG. 4 is a flowchart illustrating step 320 of FIG. 3.

FIG. 5 is a flowchart illustrating step 330 of FIG. 3.

FIG. 6 is a flowchart illustrating step 340 of FIG. 3.

FIG. 7 is a flowchart illustrating step 350 of FIG. 3.

FIG. 8 is a flowchart illustrating step 360 of FIG. 3.

FIG. 9 is a table showing a use case for a user log into the system, the use cases relate to the users, modules and the actions performed by the user in the platform. The use cases explain the scenario, actors involved, brief description, preconditions, postconditions, flow of conditions and exception conditions (if any).

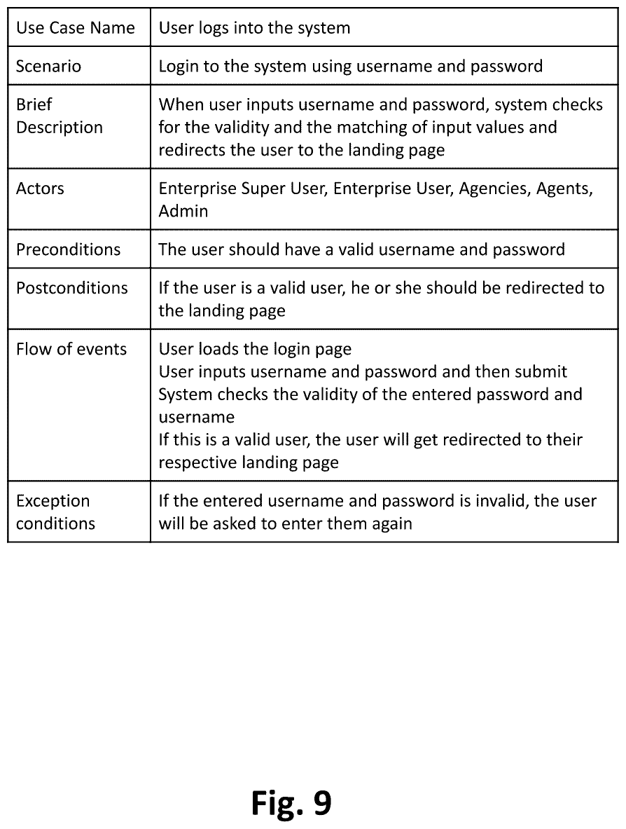

FIG. 10 is a table showing a use case for when a user logs out of the system.

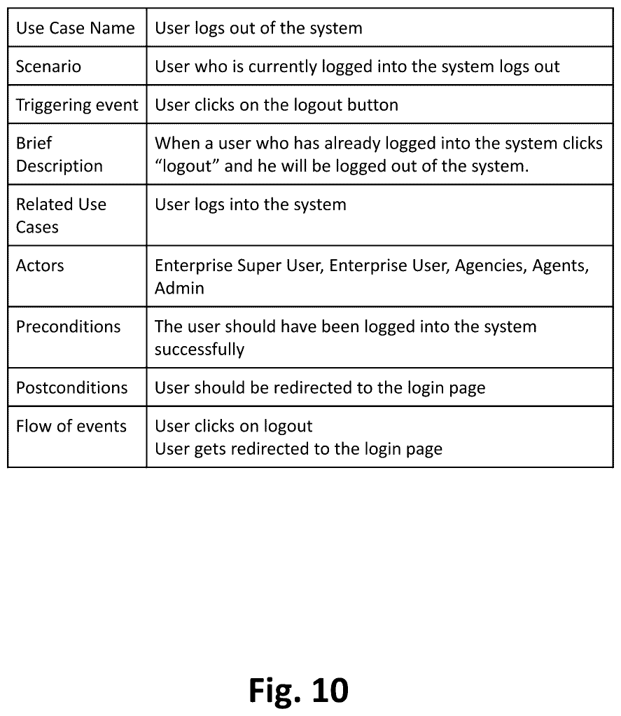

FIG. 11 is a table showing a use case for adding a new company.

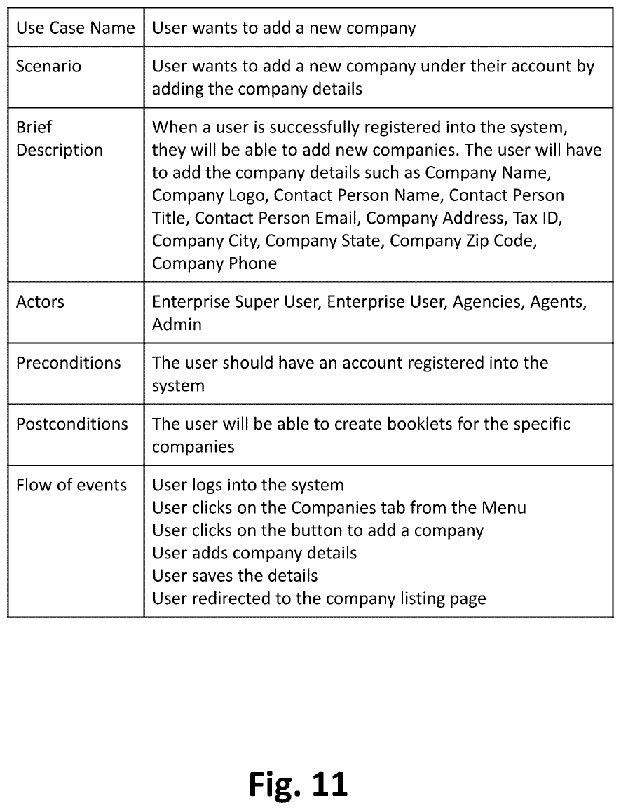

FIG. 12 is a table showing a use case for creating a new booklet.

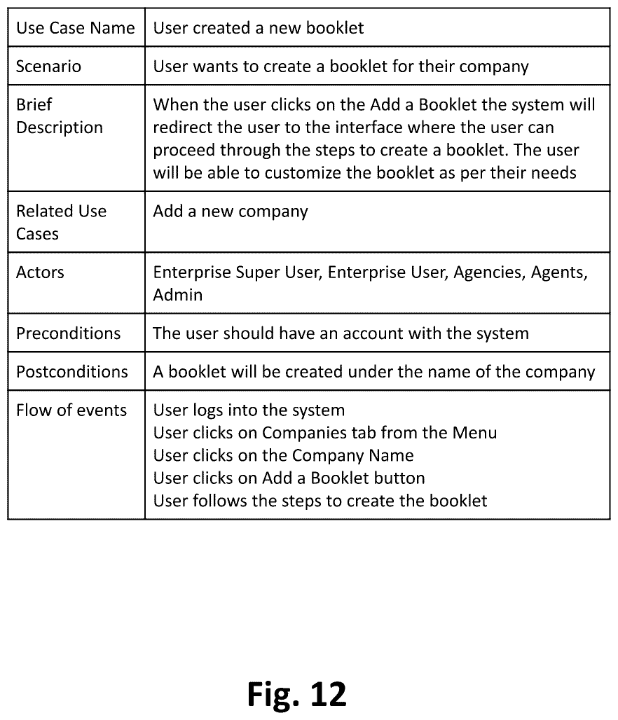

FIG. 13 is a schematic diagram that shows a high-level view of the user interaction with the system as well as the interactions between technologies involved.

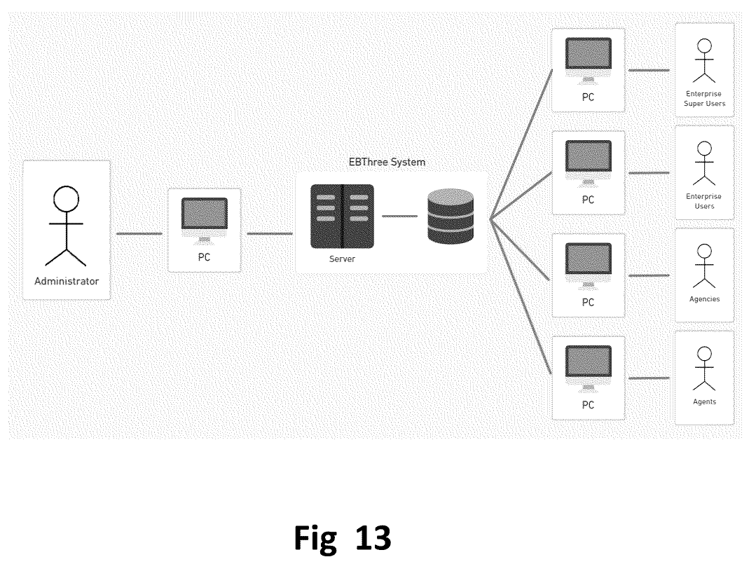

FIG. 14 is a schematic diagram that shows the modules to which the Administrator can have access.

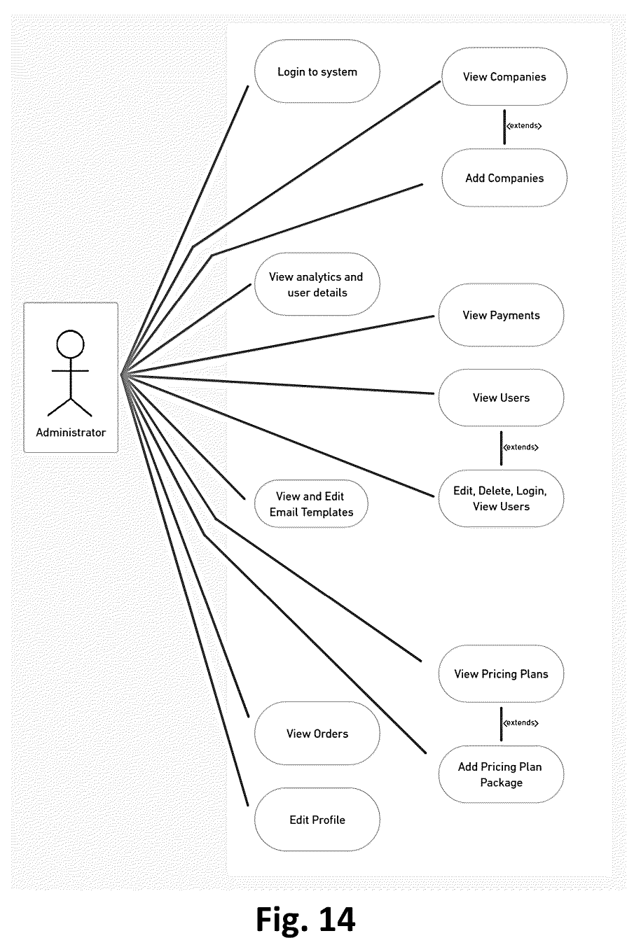

FIG. 15 is a schematic diagram that shows the modules to which the Enterprise User has access.

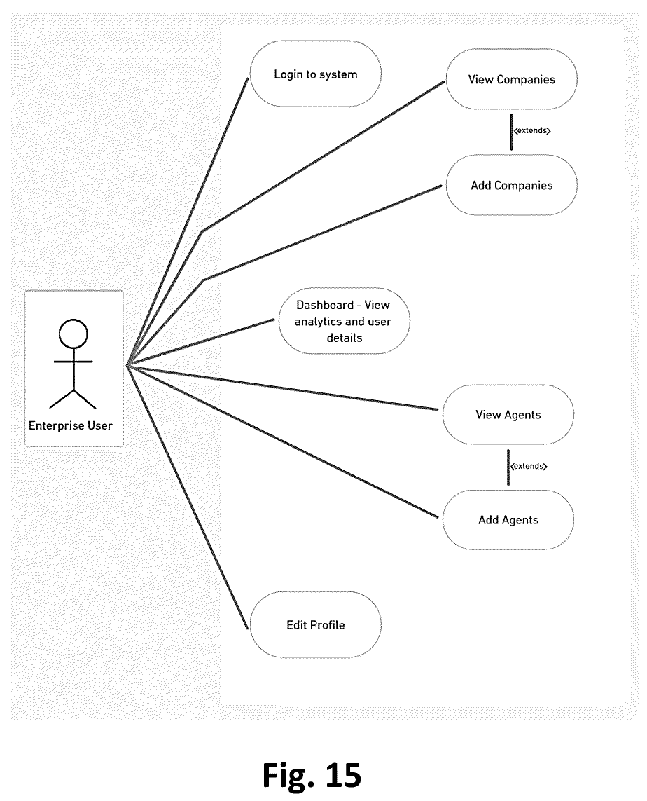

FIG. 16 shows a screen for the video tutorial section having the five steps of creating the booklet and a video frame.

FIG. 17 shows an agent's screen and permissions available for Agency and Enterprise users.

FIG. 18 shows a screen for the company's page which is a dashboard for an agent or user.

FIG. 19 shows a company information page.

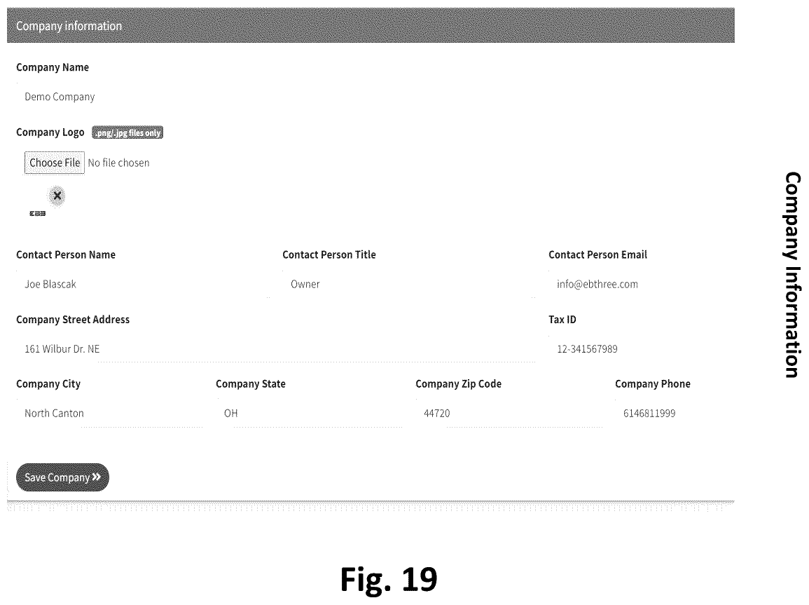

FIG. 20 is a screen for the first step in creating the booklet.

FIG. 21 is a part of the screen shown in FIG. 20.

FIG. 22 is a part of the screen shown in FIG. 20.

FIG. 23 is a screen for the second step in creating the booklet.

FIG. 24 is a screen for the third step in creating the booklet.

FIG. 25 is a part of the screen shown in FIG. 24.

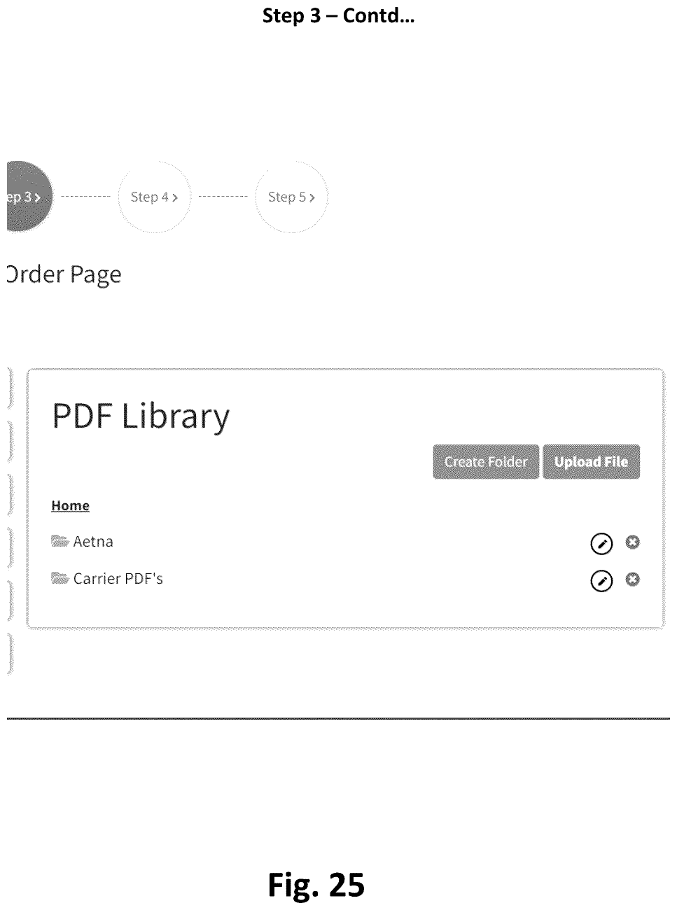

FIG. 26 is a screen for Step 4 in creating the booklet.

FIG. 27 shows another screen for Step 4 in creating the booklet.

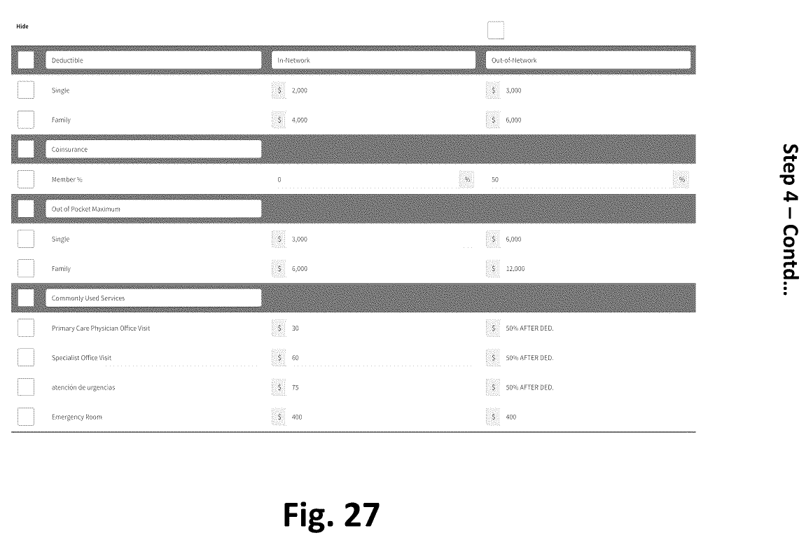

FIG. 28 is a screen for step 5 in creating the booklet.

FIG. 29 is a flowchart showing an overview of adding a new company.

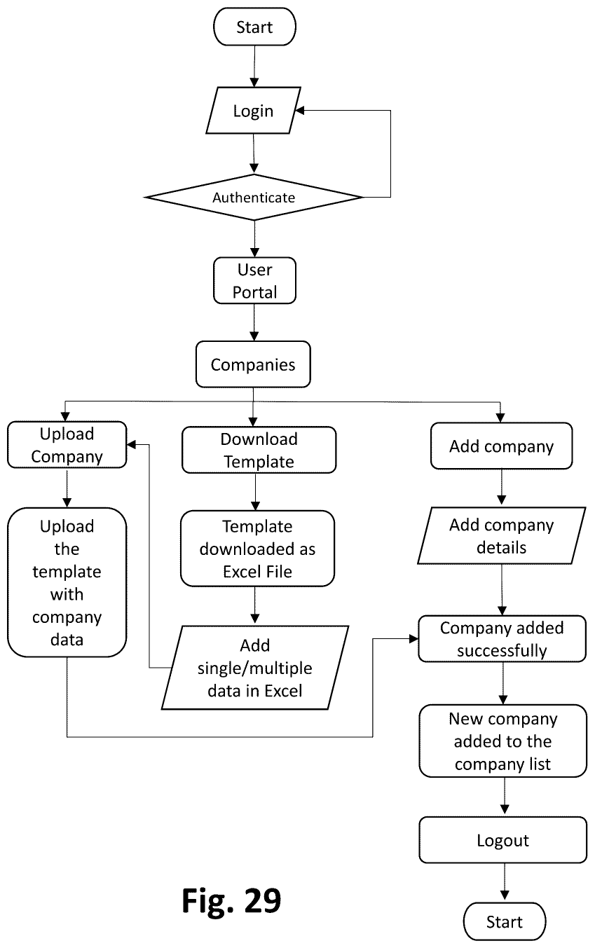

FIG. 30 is a flowchart showing an overview of adding agents to an agency.

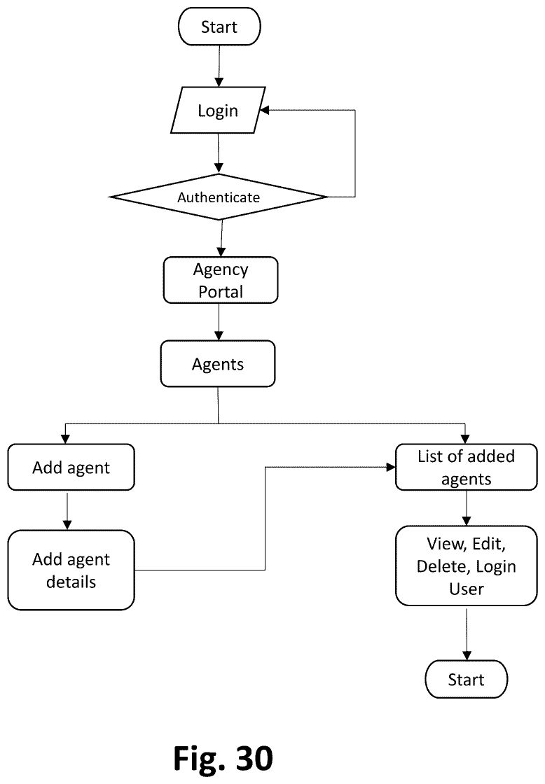

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed are a system and method for creating an employee benefits booklet. Disclosed are a system and method that allows automating one or more steps in building an employee benefits booklet. Disclosed are a system and method that allows agents of insurance agencies to create professional-looking employee benefits booklets. The employee benefits booklet can be created in a brief time with accuracy and in an organized manner. Moreover, the disclosed system and method can help in maintaining legal compliance and periodically updating the employee benefits booklet.

The disclosed system and method may allow a user to create fully customizable Employee Benefit Booklets that Agents and HR departments can provide to their employees/clients. This disclosed system may allow its users to create a Booklet, edit, update, and print.

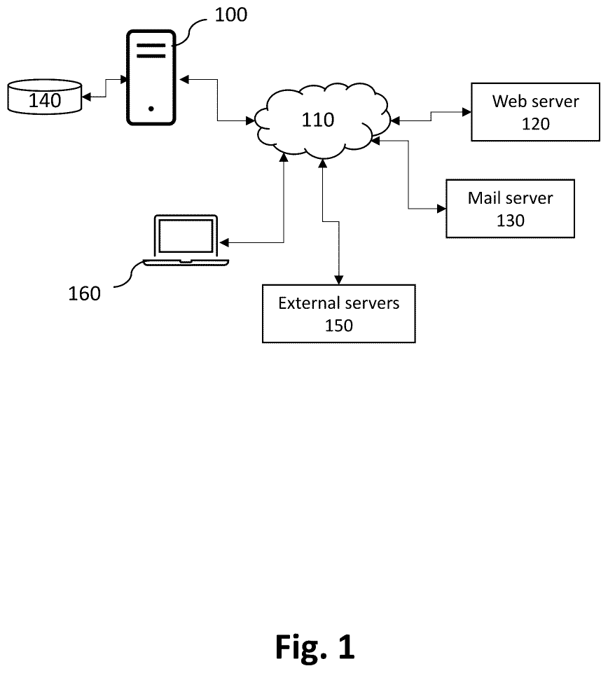

Referring to FIG. 1 shows an environment of the disclosed system 100 that outlines the major components of the overall system, subsystem interconnections, 3rd party integrations and external interfaces. The disclosed system 100 can connect to a database 140 that may store various templates, records, reports, and the like. Database 140 can be connected to the disclosed system through a network connection. Alternatively, database 140 can be a part of the disclosed system. The system may support concurrent reads from and writes to the database. The database can use MySQL architecture; however, any other database engine is within the scope of the present invention. Typically, a database stores business-related data: user's information, type of the user, companies registered under them, the booklets created. The engine where the database is handled is MySQL. The system securely stores all the given data, making the database reliable. The system functions as fast as possible and makes good memory management.

The disclosed system, through network 110, can connect to a web server 120. The web server may allow the disclosed system to access and be accessed from the internet and web browsers. The web server must serve all the web application components: CSS, images, and JavaScript. It must provide a RESTful API to allow the retrieval, insertion, update, and deletion of entities in the database. The RESTful API also provides an initial way of authenticating the user to access the application. The disclosed system may also include a Web Application that may run under Laravel, an open-source PHP web framework for the building of web applications following the Model-View-Controller (MVC) architectural pattern. The web application is responsible enough to provide a continuous, interactive, and dynamic experience to the user, allowing access to all the information that the user requests and facilitating any task that the user wants to perform over the system.

The disclosed system 100 may also connect to a mail server 130 that may allow the disclosed system to send and receive an electronic mail with or without attachments. Examples of mail servers includes SendGrid and Twilio. The disclosed system can also connect to external application servers 150 for various functionalities. The applications may include platforms and utilities, such as Stripe, LingvaNex, Google Analytics, tawk.to, Chart.js, Font awesome, Google Fonts, and the like.

The disclosed system can also connect to a user device 160 through a network 110. It is to be noted that FIG. 1 shows one user device for illustration only. A reader of this specification will appreciate that the disclosed system can connect to multiple user devices simultaneously and at various times. The user device can be any computing device, such as but not limited to a laptop, workstation, desktop computer, cell phone, tablet computer, and the like. The user device may communicate with the disclosed system through the network. The user device can send data to the system and receive data from the system through the network. The network can be a wired network, a wireless network, or a combination of a wired network and a wireless network. Examples of the network include a local area network (LAN), a wide area network (WAN), a wireless WAN, a wireless LAN (WLAN), a metropolitan area network (MAN), a cellular data network, the Internet, and the like. FIG. 1 shows a single network connecting the system to multiple devices for illustration only. It is understood that different devices can connect with the disclosed system through different networks and the same device can also connect with the disclosed system through multiple networks.

The term “user” as used herein, and throughout this disclosure, refers to an individual engaging a user device to interact with the disclosed system according to embodiments of the invention. The term user includes an administrator, an enterprise super user, an enterprise user, a person of an agency, or an agent. The different users can have different authority or access to the disclosed system.

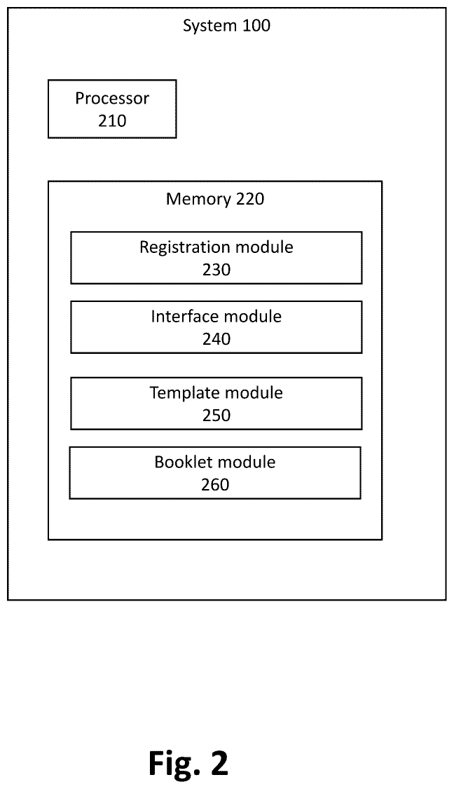

Referring to FIG. 2 is a block diagram illustrating the architecture of the disclosed system 100. System 100 can include a processor 210 and a memory 220. The processor 210 can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology. The system may also include network circuitry for connecting to the network.

The disclosed system can be implemented in the form of a server which includes a cloud server. The server includes one or more servers that may be located at the same location or geographically dispersed.

The memory can include a registration module 230, an interface module 240, a template module 250, and a booklet module 260. The module can be a software code, a set of instructions, an algorithm, and the like which upon execution by the processor performs one or more steps of the disclosed methodology. Also, it is understood that one or more steps of the disclosed methodology can also be performed on the user device, without departing from the scope of the present invention.

The interface module upon execution by the processor can provide an interface for interacting with the disclosed system, wherein information and data can be uploaded to the system from the user device through the interface and the information and data can be downloaded to the user device through the interface. Such an interface can be a graphical user interface. The interface can also operate other applications on the user's device, such as file system, web browser, printer, word processor, PDF processor, and the like.

The interface can be provided as application software that can be installed on the user device. A website-based interface is provided through the world-wide-web. The application software can also be provided for the desktop environment, such as Windows™ and macOS.

The registration module may allow a user to register with the disclosed system such that the user can securely access the disclosed system through a user device. Besides secured access, the registration module may also provide for personalized and customizable interface for the user by creating an account for the user. First, the registration module can present various information, instructions, terms and conditions, and the like to a user willing to register themselves. Users can register by adding various pieces of information like Agency name, email address, payment information, etc. Users will also be prompted to create a password which they will use to gain access to the system.

Importantly, the registration module may receive the role of the user, and based on the role, the registration module may assign different permissions to the user. The permissions define the level of access to the system that the user may have. A different interface can be provided based on the role of the user, for example, an administrator can have full access to read and edit content in the disclosed system. An enterprise Super User may be able to white-label the content on the system. In one implementation, the registration module may also create subscriptions for the users. In one implementation, the registration module may store the records of the user including subscription information and access levels in the database. The database can be a blockchain database or any other database that can securely record the contents, and any such database is within the scope of the present invention.

### Core Functionality & Features

The main functionalities of the disclosed system are 1.) to provide users with preset templates they can add benefit and rate information into and 2.) the ability to customize these templates with choices of color schemes, themes, cover page options, Backpage options, font sizes and styles, etc. The combination of these two functions can save users hours if not days' worth of formatting time.

The user can choose a desired template based on their requirements. Examples of templates include Cover pages, Back Pages, Health Insurance, Dental Insurance, Vision Insurance, Health Insurance Dual/Triple Options, WRAP SPD, Various government mandated Annual Legal Notices, etc. Also, the template module can allow the user to save their Templates of everything they have built out in the system and can use these templates to auto-populate multiple steps in the disclosed system.

The following will be detailed overviews of the various features of the disclosed system and how they work, to provide the user with a very user-friendly environment.

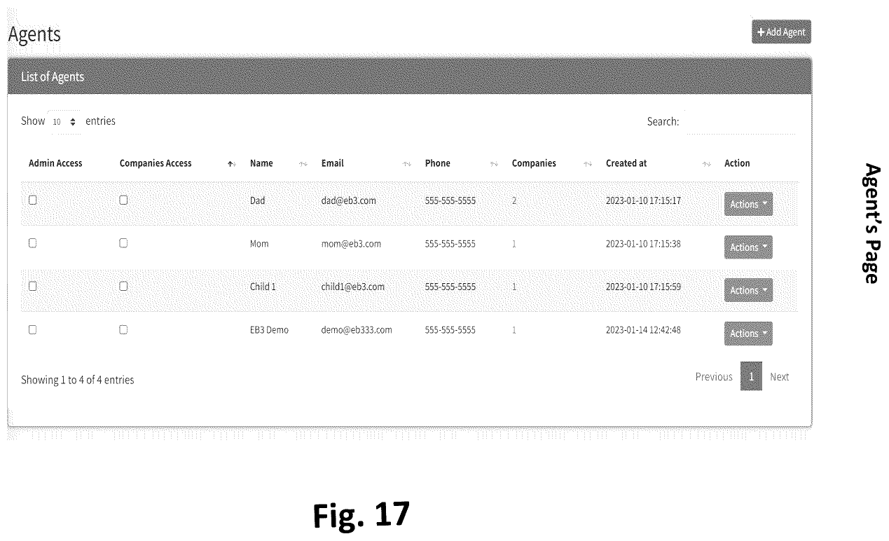

When users initially register for the disclosed system, there are multiple levels of access they can gain based on their subscription type. The first and most common is “agent” access. In this access users will only view their clients from their dashboard. While they will have full access to the system, agent access only allows one login credential. There is no need for any additional functionality for them. If a user would register for “agency”, “enterprise”, or a “super enterprise” subscription, in addition to full access to the system, they have the ability to add new users under their subscription. With this functionality, they can add, view, edit and grant/exclude permissions from these “sub users” per FIGS. 17 & 30. Per the user dashboard, permissions that can be granted are: 1.) access to all companies within an agency and 2.) admin access. Admin access grants a user the same access as the administrator of that subscription.

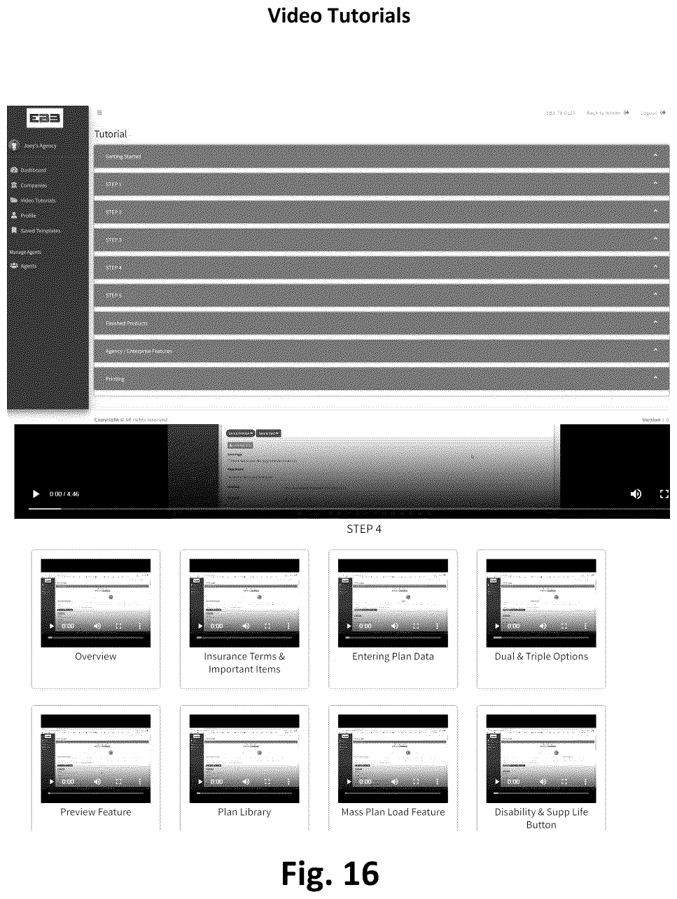

Using the video tutorials module, users are able to watch on screen instructions via video as to how to use each function of the system per FIG. 16. The videos are arranged by the various segments of the system. There are two video displays within each drop down. The first is the main video that plays all sub videos in a row without stopping. The second is the multiple sub-videos which breakdown and explain each feature and function of the system in detail, yet in shorter videos thus making it easier to access information on a single specific topic. When choosing this video tutorial module, it's worth noting that the module opens up in its own separate tab—this is done because the videos are on screen trainings and when using dual monitors, a user may watch the tutorial on one screen and update the information within the system on another screen. There are over two hours' worth of training videos in this module which are updated frequently.

To further save time for users when creating benefit booklets and compliance documents, the disclosed system has a “template” feature. This is shown in the saved templates module. This feature allows a user to save every minute detail of any booklets, compliance documents and annual legal notices they create into a template which they can save and name. Once a template is saved, it will appear in the saved templates module. From here, when a user creates a new booklet, compliance document or annual legal notice in another company, they can use any previously saved templates and apply them to this new booklet. All data that was saved in the initial template will now be populated into this new booklet. For agency and enterprise users, these templates are available to be used across all users within that agency. This saves massive amounts of time by drastically reducing any redundant data entry.

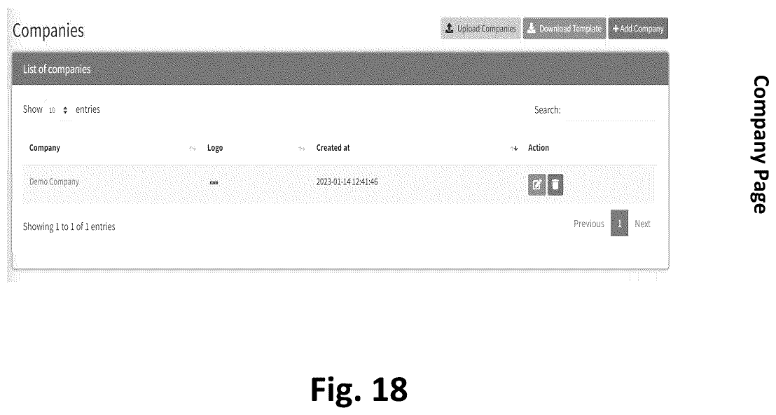

Per FIGS. 18 & 29, in the disclosed system, users can add companies one by one or they have the option to utilize an excel template the system provides, and upload multiple companies at once. After multiple companies have been entered into the system, the user has the ability to search by a specific company name to further reduce time spent in the system. When creating a company, users have the option to provide information about the company such as the contact's name, e-mail address, phone number, address, as well as information about the company, such as its tax ID. One of the many goals of this system is to reduce the amount of redundant data entry, so when these items are populated and a user chooses to create compliance documents and/or annual legal notices within the system, these fields will prepopulate wherever applicable.

The disclosed system has a hierarchy put into place between companies and booklets. users click on the company name hyperlink, and it takes them to a new screen called booklets. In this section of the system, each booklet has its own unique name (given to it by the user) so that said user can easily find the project they are looking for. Users can create unlimited amounts of booklets in the system. Please note that while the header for this section says booklets, this section incorporates booklets, compliance documents and annual legal notices as well-They are all included in the section as you create them all at the same time within the same disclosed system.

Users can edit any booklet at any time. This is particularly useful when a user needs to make a small change to a document they've created or if they need to update information at renewal time.

Users also can make a carbon copy of any of the booklets within their system. This can be useful when you do not wish to overwrite a previous booklet but wish to make a new booklet and incorporate a few minor changes. For example, a user may have created booklets and compliance documents for the year 2022. When it's time for the renewal in 2023, the user may wish to keep a lot of the information within the documents the same but the insurance rates or contributions from the employer may have changed. This is a very small tweak that can be made in the system and can be done quickly. If the user copies said 2022 booklet, renames the copy 2023 booklet and makes the small applicable changes, this saves a massive amount of time that would have been spent creating a new booklet from scratch.

Users can download a flip booklet. Once a booklet is completed, instead of exporting it to a PDF document, users can click on a button and obtain their booklet in a digital flipbook which allows them to view the contents of their booklet and turn digital “pages” which resembles turning the pages of a book. They can share the link of this flipbook with their clients. This feature has a very nice aesthetic appeal.

The disclosed system provides users with the ability to have their entire booklet translated into Spanish in the click of a button. Using a separate server with translation software incorporated into it, each line of editable and non-editable text is sent to this server from the system one by one to ensure the most accurate possible translation. This translated text is sent back to the system and is formatted into the benefit booklet. The benefit booklet is then emailed directly to the user, and they can obtain the translated booklet via a link.

A byproduct of entering information into the system is the election sheet. Election sheets are used by companies as a means to collect benefit elections from their employees. This is done in the absence of electronic enrollment which has become prevalent for many Gray and white-collar industries. A lot of blue-collar industries do not use electronic enrollment as they receive pushback from their employees. Thus, the need for the paper election sheet. When employee payroll deductions are calculated or entered into the disclosed system along with applicable insurance plan information, the election sheet is pre populated—it requires no other data entry from the user, thus saving a lot of valuable time. The plans and rate types listed in this election sheet are truly dynamic, which means each specific plan, plan name, rates and rate types only populate when selected or entered into the system. This selection sheet shows the plan names, payroll deduction amounts available to each employee as well as boxes to make the elections. It also incorporates a section with prefilled text where an employee can fill in the personal information required by insurance carriers to enroll them and their families into the selected benefits. Furthermore, the sheet gives them a space to sign and date to make the elections official.

Another byproduct of the disclosed system is the premium breakdown sheet. Like the election sheet, this sheet is totally dynamic and dependent on the plans, rates, contributions, and rate types that are selected and entered into the system. It is also similar to the election sheet in that it does not require any additional data entry from the user—is created merely as a byproduct of information already entered in the system and populated into its specific format. The premium breakdown sheet takes all the monthly premiums, employer contributions and payroll deductions and lists them all in one document.

Users also have the ability to download an editable PDF document in the instance they would like to make further changes to the document outside of what the system allows.

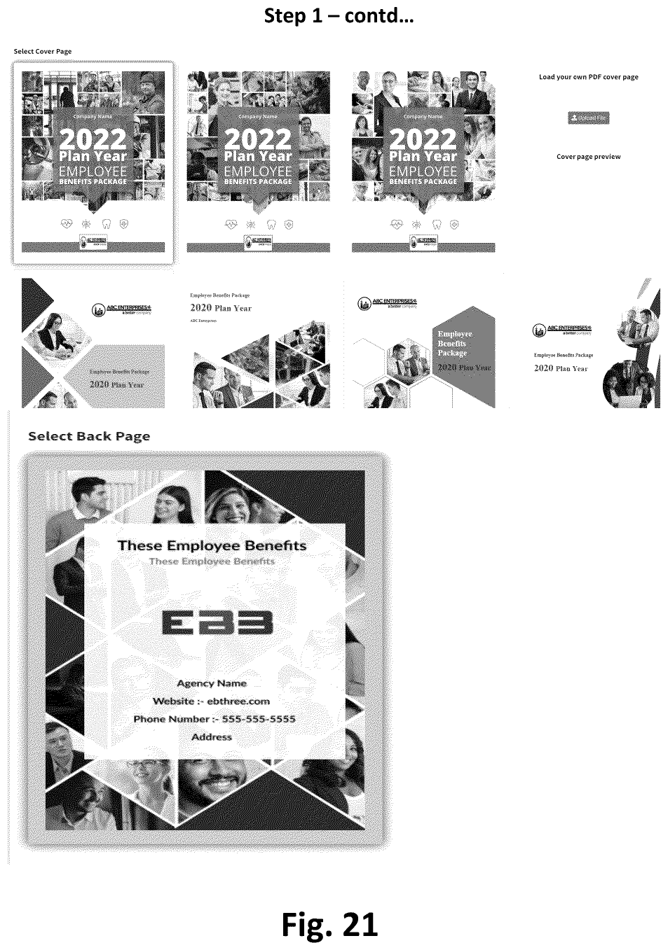

Per FIGS. 21 & 22, users have the ability to add cover pages, back pages, and themes to their booklets. The disclosed system offers ten different preset cover page templates to choose from, or users can upload their own cover page. The system gives the option to add a back page to the booklet as well-text and logos maybe edited for both the cover pages and the back pages. Finally, users have the ability to choose between two different themes for the booklet style-one is a very plain theme with headers and grids and the other is a more colorful theme with headers multiple stock photos and colorful grids. Users have the ability to choose from various stock photos inside the system.

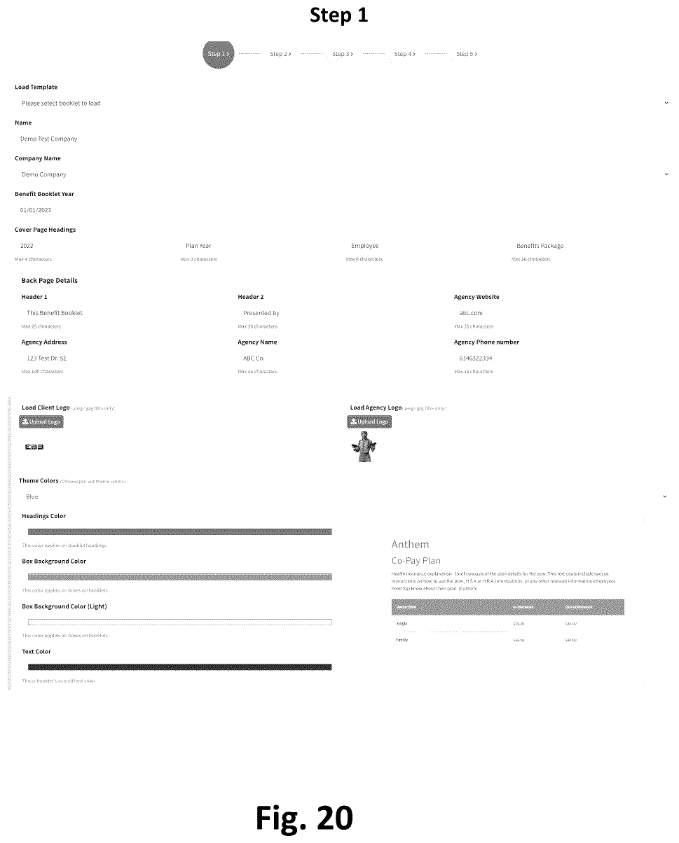

Per FIG. 20, the disclosed system gives users the ability to choose color schemes for the booklet, cover pages, and back pages. The system includes twelve different preset color schemes, and within those, users can change around the preset shades of colors and even enter in specific RGB numbers to specify exact shades.

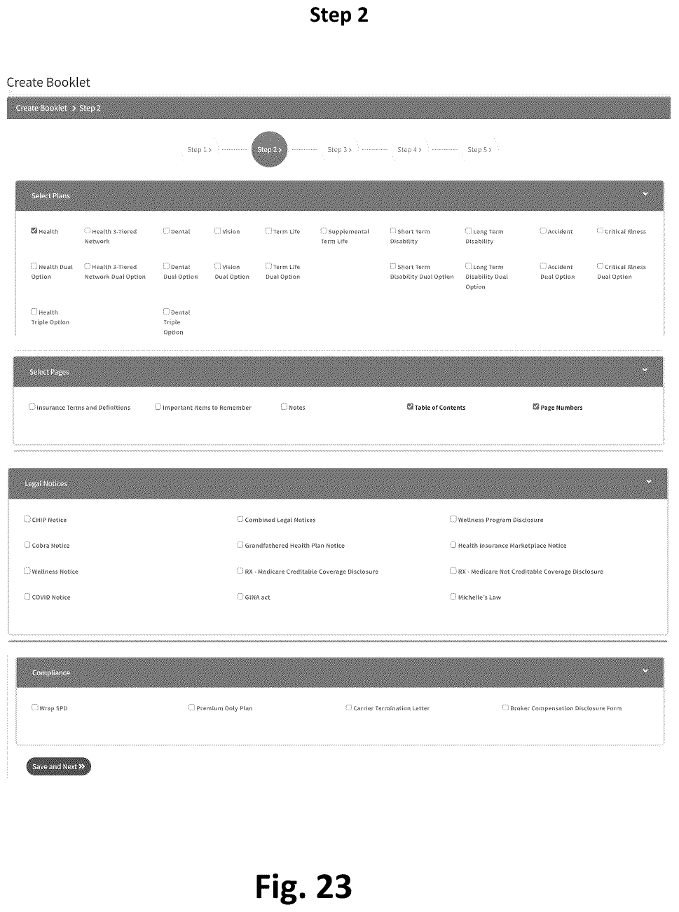

Per FIG. 23, users can select the plans, pages and annual legal notices they want to incorporate into their booklet in a click of a button-simply click the button next to the plan or page you'd like to add, and it will be loaded into the booklet. At the same time, users can also select which compliance documents they would like to create that with the click of a button.

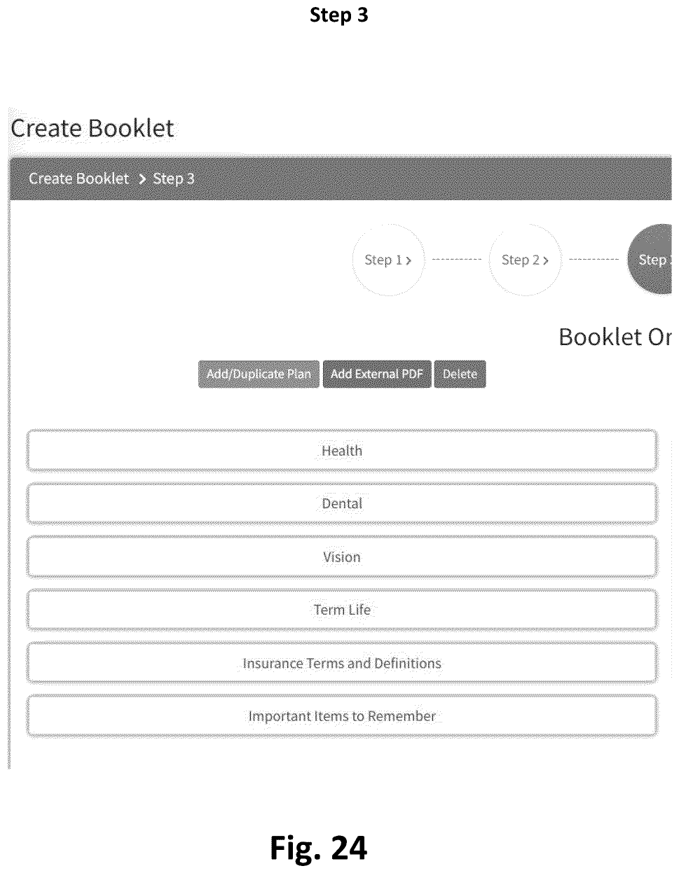

Per FIG. 24, users can organize their booklets by adding a table of contents and page numbers. To save on time, to add these features simply click on the buttons next to them and they will be added into said booklet.

Also, per FIG. 24, To further organize the pages of the booklet, the disclosed system allows users to drag and drop booklet pages in a vertical fashion. By dragging and dropping a page above another page, the top page will now be first in the booklet itself. And vice versa for the page on the bottom. When dragging and dropping pages in the desired sequence, the table of contents and page numbers are automatically and dynamically updated. Users also have the ability to duplicate Pages.

Per FIGS. 24 & 25, the disclosed system offers users a way to truly customize their booklets by incorporating their own PDF documents. Incorporating these can be done in two ways. First, users can click on “add external PDF” within the system and upload a single PDF document into the booklet and can then use the drag and drop feature to arrange it at their leisure. Second, the system provides a PDF library for users. Users can create folders and up to three subfolders where they can upload, name, and view multiple PDF documents. These documents in the PDF library can be added to the booklet with the click of a button. This allows users to load frequently used PDF documents into the system so that they may be used by any user within their agency subscription. This also drastically cuts down on the time it takes to load frequently used external PDF documents one by one.

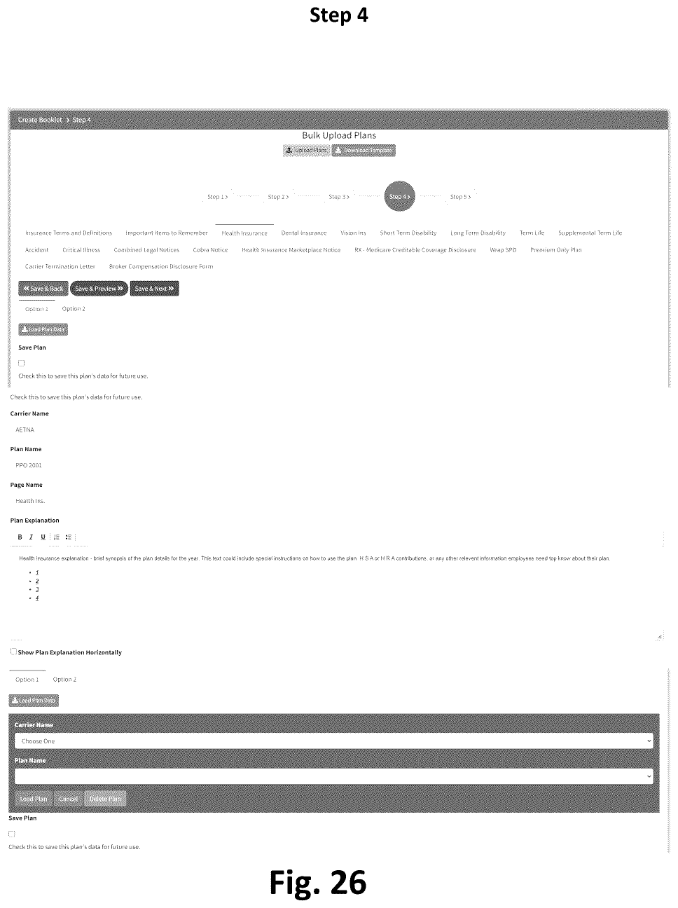

Per FIGS. 26 & 27, when creating benefit booklets or any type of compliance document there can be a lot of data entry involved. At times, due to workflow, meeting obligations, phone calls, etc., it can make completing a booklet in one sitting potentially challenging. Thus, the disclosed system has incorporated a “save and next” feature. When entering the data for each benefit plan, page or document, each of these is separated into its own tab. When you load the data requested in one tab then move to another using the save and next feature, all data is saved in the system. This alleviates any data loss that may occur When the user remains idle for an extended period of time and the website times out.

Per FIG. 26, the disclosed system offers its users a method to store data entered for specific plans and pages. When a user enters plan information or page information, they can save it in a plan library with the click of a button. This saved plan or page can then be used across their entire list of companies and any new or existing booklets via 3 button clicks. Users also have the ability to upload multiple plans and pages at once using the systems bulk upload plan excel template-when uploaded, multiple plans are loaded into the plan library.

The disclosed system provides a feature where the user can change the font size and style for various headings, tables, and text. The font size can be changed and amended for each plan and page in the booklet.

Per FIG. 26, users have the ability to preview various plans and pages they are loading into the booklet as they build it. This can be accomplished by clicking on the save and preview button. Users can make changes to a particular plan or page and can view the changes in real time by clicking on said button.

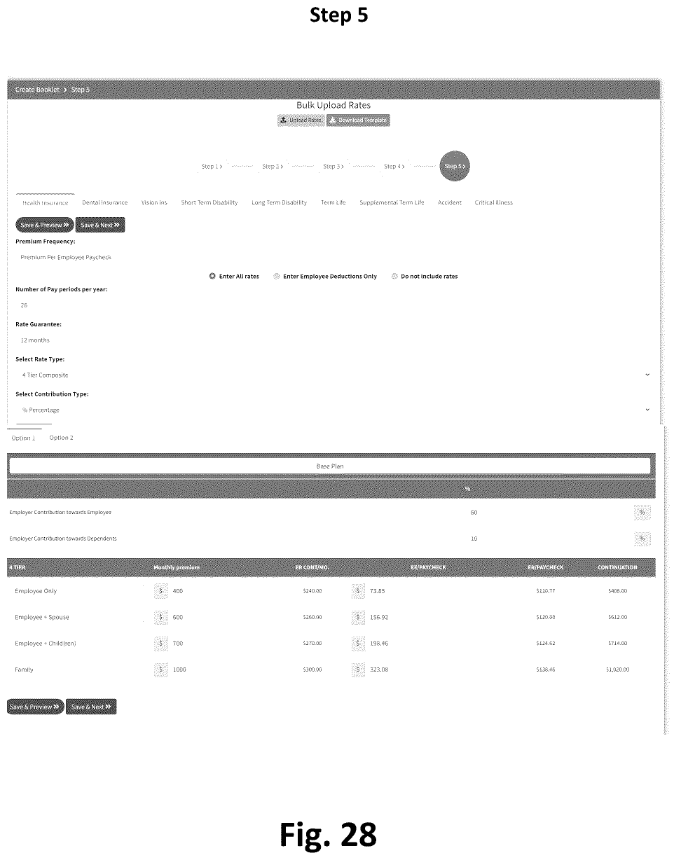

Per FIG. 28, the disclosed system gives users three different options when choosing how and if they will load premiums and/or payroll deductions into their booklet. The first option is to not include any rates at all—this feature is often used if a user deems that a specific line of coverage is 100% employer paid or if they had a very complex payroll deduction grid they would like to enter into the system as a PDF instead of manually typing it. The second option allows users to enter payroll deductions only—this is often selected when a user may not have the monthly premiums or contributions from the employer. The third and most commonly used option is to enter all rates—in this option users load in the number of annual pay periods, rate type and contribution type. Once these three fields are chosen and the data is entered, the system performs the math calculations behind the scenes and immediately returns the employer's monthly contribution, payroll deduction amount for the employee as well as the continuation rates.

Per FIG. 28, users have the ability to utilize a bulk upload rate excel template. There are many rate types that require quite a bit of data entry and if the user already has this data in an excel format they can simply copy the data from their excel insurance quote and then paste it onto the bulk upload excel rate template. From there, they can upload the completed template into the system and the monthly rates will populate in the applicable fields—this can alleviate a lot of data entry.

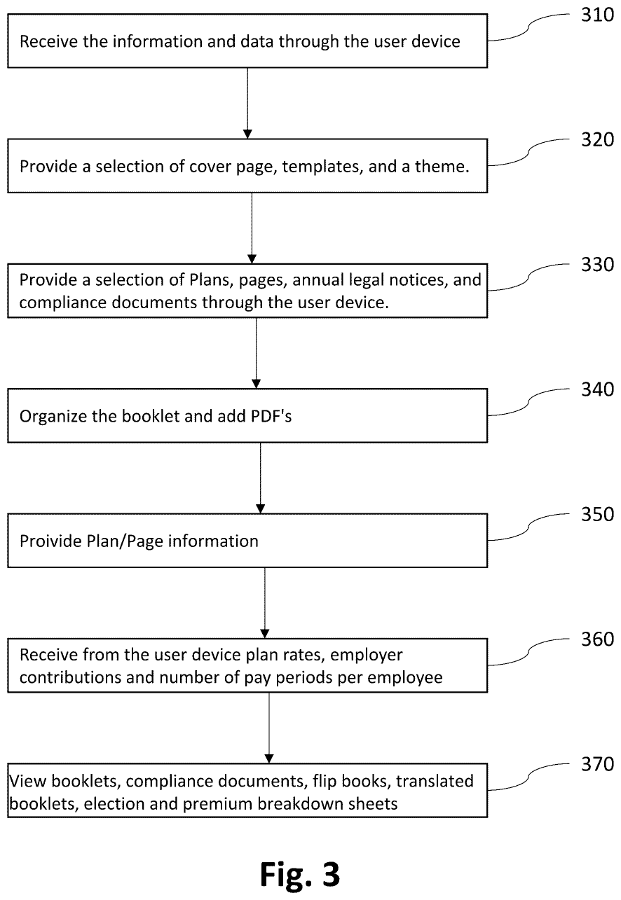

Referring to FIGS. 3-8, & 16-28, which show an interface for creating a booklet. Create Booklet: The users will be able to create a customized booklet based on their necessities and requirements for their company. The users will have to follow a simple five step process to create a new booklet. There will be no limitation on the number of booklets, so the users will be able to create unlimited booklets for their company.

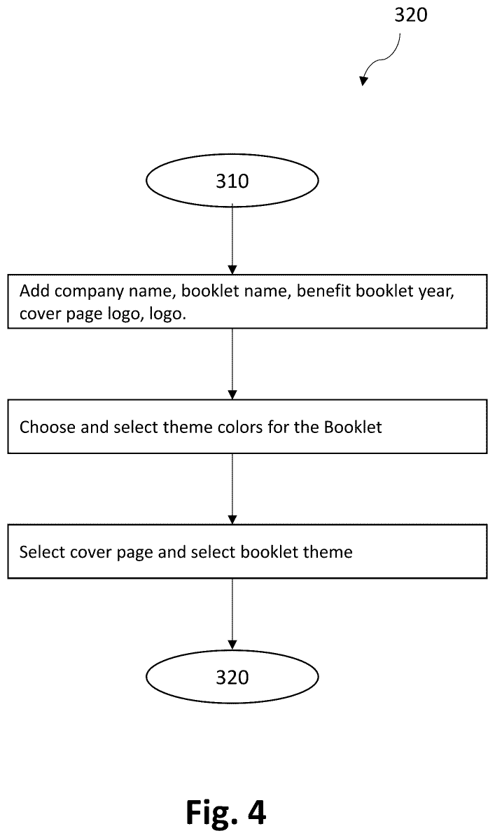

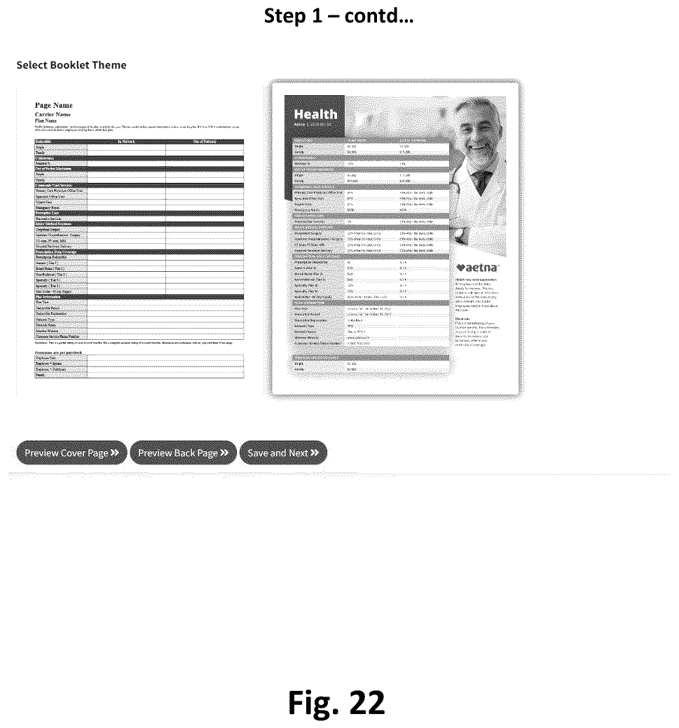

### Step 1 (Shown in FIGS. 4 and 20-22):

This is the initial step in creating a booklet. The user will have to enter the information through an interface provided by the disclosed system as shown in FIGS. 20-22. In this step users can select between various color schemes for the booklet, choose a cover page or upload their own, select a back page and choose between a plain and stock photo theme for the booklet. Once the user has completed these items, they will be able to proceed further to the next step.

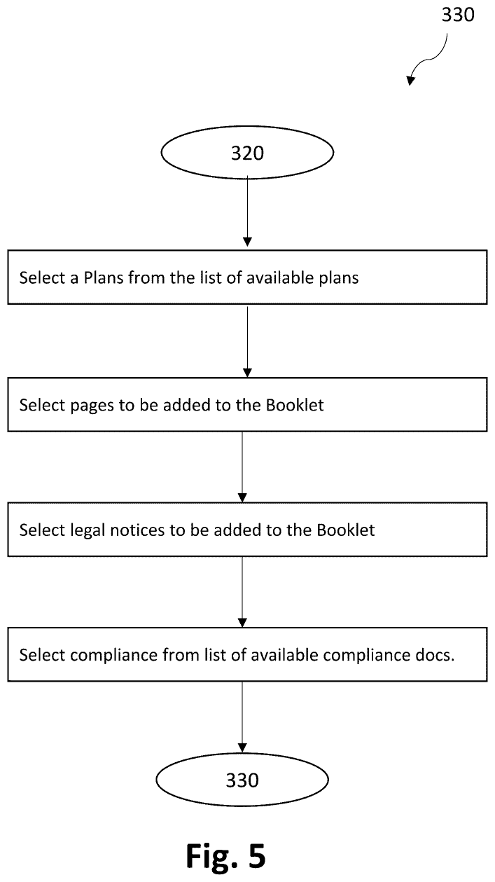

### Step 2 (Shown in FIGS. 5 & 23):

The user will have to select the plans, pages, and Legal Notices to include in the booklet. Compliance documents are selected in this step but are not included in the booklet themselves. They are created in the system and then are downloaded separately. The list/options for each will be hard coded. Each of the options will have a link so the users will be able to click on it and preview each of the pages.

The options for each of the sections include Select Plan: Health; Health Dual; Health Triple; Health 3 Tier; Health 3 Tier Dual; Dental; Dental Dual; Dental Triple; Vision; Vision Dual; Life; Life Dual; Supp Life; STD; STD Dual; LTD; LTD Dual; Accident; Accident Dual; Critical Illness; Critical Illness Dual, Hospital Indemnity; Hospital Indemnity, Dual Option; Pet Insurance.

Combo Pages: Dental & Vision; Life, LTD & STD. NOTE: The above is just a couple of examples.

Select Pages: Insurance Terms and Definitions; Important Items to Remember, Notes, Table of Contents, Page Numbers, HSA, HRA, GAP, Commuter FSA, FSA, Legal Shield, Teladoc, and ID Theft.

Legal Notices: Chip Notice, Combined Legal Notices, Wellness program disclosure, cobra notice, grandfathered health plan notice, health insurance marketplace notice, Wellness notice, HIPAA notice, RX Medicare creditable coverage disclosure, RX Medicare not creditable coverage disclosure, COVID notice, Gina act and Michelle's law.

Compliance: WRAP SPD, premium only plan, carrier termination letter, and broker compensation disclosure form.

Once the user selects the pages they want for their Booklet, they will have to Save and move to the next step.

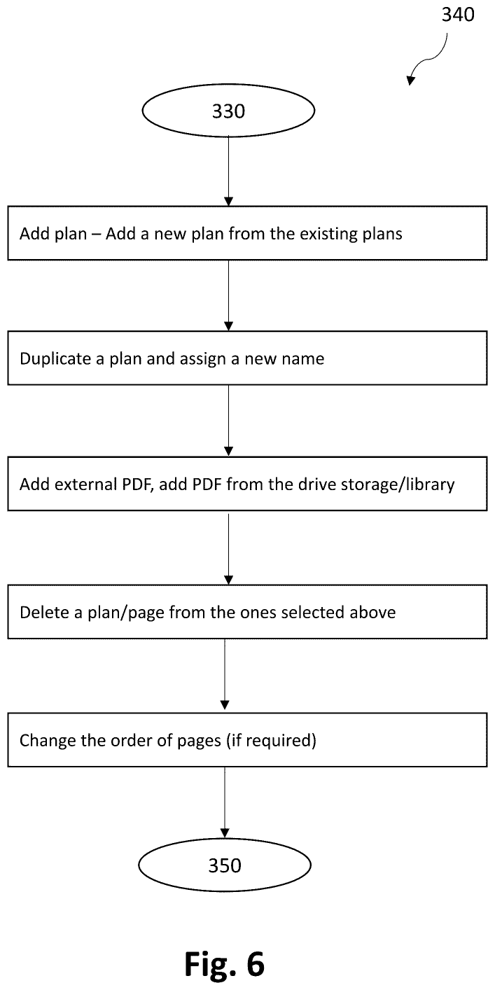

### Step 3 (Shown in FIGS. 6 & 24-25)

This interface allows the users to set an order of the pages of the booklet. The users can drag the pages up and down to set the order of the pages.

Add Plan: The user can also Add a Plan from this interface. When the user clicks on this button, a popup will be shown through which the user will be able to select plan(s).

Duplicate: The user will be able to duplicate a plan from the list of plans selected.

Add External PDF: The user will be able to add an external PDF that they wish to add to the booklet.

Delete: The user will be able to select single/multiple plan/pages and will be able to delete it from the Booklet Order Page. Once they delete it, those would not be a part of the booklet that will be created.

An option to add the table of contents will be provided to the users in Step 2. If the users choose the table of contents option, they will be able to edit the text/content for the title of the booklet pages via the text of each row in Step 3.

The user can load PDF documents into a PDF library. The user can create folders and up to three subfolders where they can load edit and view frequently used PDF documents that they would like to include in their booklets. Through a click of the button any PDF documents loaded into the PDF library can be added into the booklet itself and arranged via the drag and drop feature. Any documents added into the PDF library or available to be used by any user within an agency can be used for any booklet.

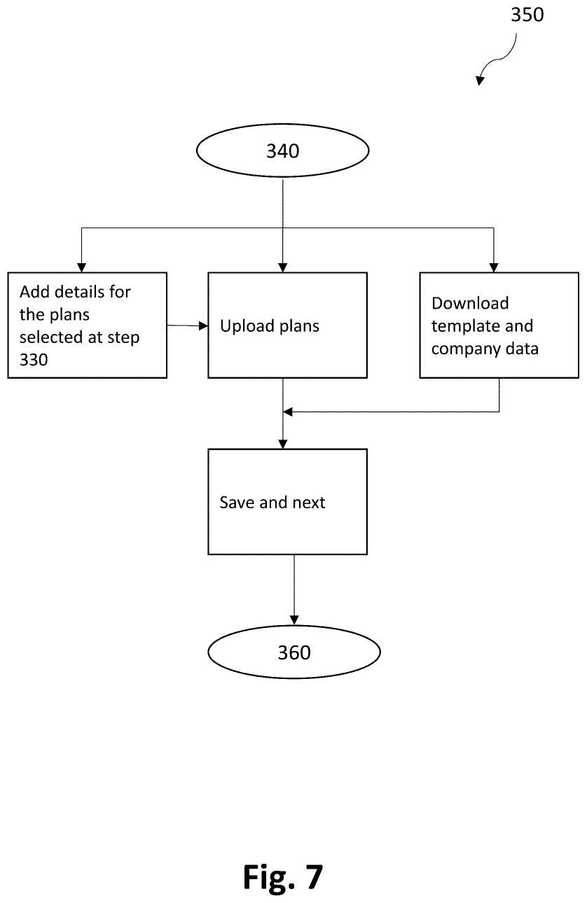

### Step 4 (Shown in FIGS. 7 & 26-27)

The details on Step 4 will be shown based on the selections made in Step 2. The user can add the plan information into the pre-set templates based on the plans/pages selected. Each plan/page has its own template for data entry.

The users are also provided an option to disable a section. When the user selects this option, they will be able to remove an entire section from being added to the booklet.

The user can add the Page Name, Page Explanation and Carrier Name, Plan name where applicable for the plans to be included in the booklet.

If the user selects any of the dual/triple plans, for example: Health Dual, Health Triple, they will have to add the data accordingly. Option 1, Option 2 and so on will be provided to the users to add the data for dual/triple plans. The user will have to add other information based on the plan selected.

The users will be provided an option to Save the Plan data they have populated. Once the user saves the plan, they will be able to use the same plan with the same details in any of the booklets they create for any other company within their subscription. They will be provided an option to Load the Plan Data that they have saved earlier.

The fields in this step for the Pages selected by the user will be shown based on their selection in Step 2. They will be able to read/manage/edit the content for the pages of the booklet. They will be provided with an option to save the page for later use. They will be able to load the page data if they want in a different booklet, as they have done for the Plans as previously mentioned.

The users will be able to disable a specific item if they do not want it on their booklet.

The users will be able to add extra rows for the Plans they have added. An ‘Add’ button will be provided to them clicking on which a new row with ‘no data’ will be added.

Legal and Compliance—The data added for notices in step 4 will be saved. The user will have the ability to populate the provided fields while creating a booklet.

Download Template: The users will be able to download a Bulk Plan template. After they have downloaded the template, they will be able to add multiple plan and page data to the file template.

Upload Template: The users will fill in the data in the template and upload it to the plan library. Once loaded, users can then choose from any of the uploaded plans when creating any new booklets for any other companies.

Users can select from any pre-loaded images to customize their booklet pages, or they can choose to upload their own images.

Users can select font size for any of the various headers, paragraphs, tables or text boxes.

After any changes are made in Step 4, users can view the specific plan or page they are working on by clicking the save and preview button. This button opens in a new tab and gives the user a real-time preview of that specific page.

The users can Save and move to the next step.

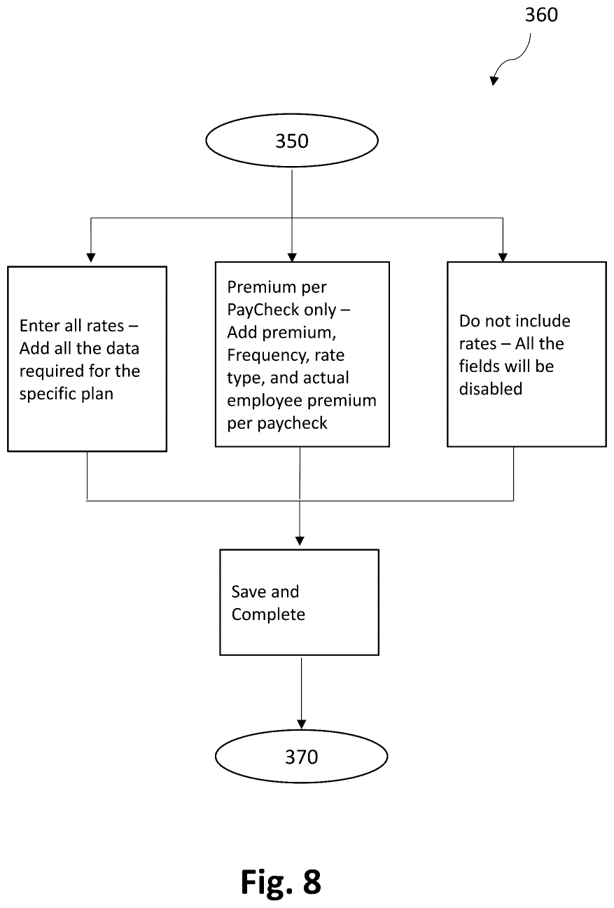

### Step 5 (Shown in FIGS. 8 & 28)

This will be the final step for the users to create their booklet. The users will have to add the rates and contribution in this step.

The user will have to add the following details:

### Premium Frequency

### 3 Different Rate Options:

Enter All rates—If the user selects this option, then they will have to add all the monthly rates and employer contributions required for the specific plan. The system will perform backend calculations based on the entries made by the user. If any of the sections are missed by the user, an error will be shown to the user for the field that has been missed by the user.

Enter Employee Premium per Paycheck Only—If the user selects this option, then they will only have to enter the Premium Frequency, rate type and the actual employee premiums per paycheck.

Do not include rates—If the user selects this option, then they will not have to add any of the rates required for the specific plan.

Number of Pay periods per year.

### Rate Guarantee

Select Rate Type (Dropdown)—The dropdown option for rate types will be the same for all the plans.
2 Tier Composite
2 Tier Composite Incentive
3 Tier Composite
3 Tier Composite Incentive
4 Tier Composite
4 Tier Composite Incentive
8 Tier Composite
8 Tier Composite Incentive
ACA Rates
5 Year Age Banded Rates
Life—DI Unit Rate
Life—DI Age Banded Rates
Accident Rates
Critical Illness Rates

### Select Contribution Type

% Percentage
   $$ Fixed Dollar
   $$ Total Dollar
4 Tier % Percentage
4 Tier $$ Fixed Dollar
ESC % Percentage
ESC $$ Fixed Dollar

For plans with multiple options, premiums and contributions are added for Option 1/Option 2/etc. based on the plan selected.

Once step five is completed, the user will have the option to save the booklet in its entirety as a template by clicking on the save template button. From here, the user can name the template and save it to be used for other booklets within their subscription.

The user will have to Save the details to complete the final step by clicking the save and complete button.

Once the user completes all the steps included in the process to create a booklet, they will be redirected to the Booklet Listing page.

### Booklet Options

Once a user has completed a booklet, they can click on the booklet actions dropdown menu in the booklet listings page. Below is the list of options they can choose from:

Edit booklet-Once a user has completed a, they can revisit the five-step builder by clicking on this button and are able to make any changes needed.

Delete Booklet.

Copy Booklet—users can make a carbon copy of an existing booklet and make any changes necessary.

View booklet—the finished booklet will appear in a new tab in electronic format that can be printed or downloaded to a PDF document Download booklet—the booklet will download to a PDF document.

Edit PDF—the finished booklet will appear in a new tab in electronic format as an editable PDF document

Flip booklet—the finished booklet will appear in a new tab in an electronic flip book format that resembles an actual book with page turning and applicable sounds.

Download Spanish booklet—the finished booklet will be translated into Spanish and emailed to the user with a clickable link.

Election sheet—the user clicks here to download a PDF file of the previously mentioned election sheet.

Premium breakdown—the user clicks here to download a PDF file of the previously mentioned premium breakdown sheet.

WRAP SPD—the user clicks here to download a PDF file of the previously mentioned WRAP SPD document.

Premium only plan—the user clicks here to download a PDF file of the previously mentioned premium only plan document.

Carrier termination letter—the user clicks here to download a PDF file of the previously mentioned carrier termination letter.

Compensation disclosure form—the user clicks here to download a PDF file of the previously mentioned broker compensation disclosure form.

### Profile

The users will be able to edit/update/manage their basic details from the profile section. The common fields for all the users will be the following:
Name
Email
Password
Phone Number
Profile Picture

### Speech to Text

The users will be provided with a Speech to text feature in the header, clicking on which the users will be able to enter the content in the input boxes by speaking while creating a booklet.

Spreadsheet functionality-through an interface within the system, users will be able to create multi carrier spreadsheets for various lines of insurance coverage and customize these plans and sheets.

Self-funding reporting—through using the existing interface within the system, users will have access to preset templates where they can populate a company's plan rate and claims information for multiple years to showcase various necessary reporting details as well as renewal information for large self-funded clients.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

1-18. (canceled)

19. A computer-implemented method for a model-view-controller system architecture for arrangement of graphical user interface elements for producing employee benefit booklets within a system comprising a processor and a memory, comprising:
Providing, by a controller, a RESTful API to a user device;
receiving user registration data at the controller through the RESTful API;
accessing a MySQL database model storing permission data;
accessing, by the controller, one or more 3^{rd} party integrations for one or more of data storage, translation, and pdf merging;
providing in a view, based on a comparison of the application of the user registration data to the permission data, a selection of a color scheme, a cover page, a back page, and a theme for the booklet through a first screen of a user interface implemented on a user device;
receiving the data at the controller through the RESTful API a selection indicated on the first screen, storing the selection in the MySQL database and applying the selections made to the booklet;
providing in the view, based on a comparison of the application of the user registration data to the permission data, a second screen of the user interface displaying plans, pages, compliance documents, and legal notices for incorporating into the booklet wherein the second screen comprises a plurality of plans, a plurality of pages, a plurality of legal notices and a plurality of compliance documents, wherein the second screen is configured to permit selection of one or more plans from the plurality of plans, one or more pages from the plurality of pages, one or more legal notices from the plurality of legal notices, and one or more compliance documents from the plurality of compliance documents;
receiving the data at the controller through the RESTful API a selection indicated on the second screen, storing the selection in the MySQL database model and pulling the selected templates from the MySQL database model to be used and populated in subsequent screens;
providing in the view, based on a comparison of the application of the user registration data to the permission data, a third screen of the user interface displaying an order of pages in the booklet, plans to be added, and documents in PDF format to be added, wherein the PDF documents are stored in a PDF library that may be shared with other users, wherein the third screen is configured to permit changing the order of pages using drag and drop functionality;
receiving at the controller the data through the RESTful API the booklet page order processed via the drag and drop feature and PDFs added to the booklet indicated on the third screen and storing the selection in the MySQL database model;
providing in the view, based on a comparison of the application of the user registration data to the permission data, a fourth screen of the user interface displaying pre-set templates of plans, pages, legal notices and compliance documents based on the selection of plans, pages, legal notices and compliance documents received through the second screen, the information about the plurality of plans, pages, legal notices and compliance documents comprises Page Name, Page Explanation, Carrier Name, Plan name, Deductible, Coinsurance, Out of Pocket Maximum, Company Name, Tax-ID, HR contact person names and several hundred additional fields that may be added, wherein the information is collected manually or uploaded, then saved as plan data in a plan library in the MySQL database model, wherein the fourth screen is configured to permit downloading an existing plan data and saving a new plan data;
wherein the fourth screen is configured to permit font size and stock photo image changes to enable customization of the booklet via external applications;
receiving at the controller the data through the RESTful API a selection indicated on the fourth screen and storing the selection in the MySQL database model;
providing in the view, based on a comparison of the application of the user registration data to the permission data, a fifth screen of the user interface displaying selections for rates and contributions, wherein the fifth screen comprises a plurality of tables for entering the rates and contributions; wherein the fifth screen comprises a plurality of formulas on the backend of the system that perform calculations for the above-mentioned rates and contributions via customized Javascript files;
receiving at the controller the data through the RESTful API a selection indicated on the fifth screen and storing the selection in the MySQL database;
providing in the view, once the user has made their selections and completed all provisions in the first through the fifth screen and all data and selections have been stored in the MySQL database;
wherein the user is then presented in the view plurality of options to choose from in terms of exporting their finished booklet comprised of a PDF Booklet, A Booklet Link, a digital flip booklet, a Spanish translated booklet, various compliance documents downloadable in PDF, a dynamic customized election sheet and a dynamic premium breakdown sheet;
wherein all of the above-mentioned options are generated using a combination of the saved information from the MySQL database model, web application components and a plurality of external applications.

20. The method according to claim 19, wherein the method further comprises:
presenting a video tutorial through a sixth screen of the user interface on the user device, the sixth screen comprises a main video frame and a plurality of sub-video frames, the sixth screen is configured to present a continuous video stream in the main video frame and a plurality of segments of the continuous video stream in the plurality of sub-video frames, wherein each of the sub-video frame of the plurality of sub-video frames can be played independently wherein these videos provide users with extremely detailed information about how to use the various components of the system and are integrated into the system via web application components and a third-party application for video software.

21. The method according to claim 19, wherein the method further comprises:
receiving a user template; saving the user template in saved templates module, wherein multiple users have access to the saved templates module and providing the saved template on a second user device for creating a new employee benefit booklet wherein this feature is used to get rid of hours of redundant data entry, wherein in lieu of storing plans, pages, legal notices and compliance document data one by one, this feature allows a user to store all the data as a whole for use within another client and is made possible via the saving all this data to its own table in the MySQL database.

22. The method according to claim 19, wherein the method further comprises:
receiving through the second screen, compliance documents, wherein the compliance documents are not included in the booklet, wherein the data entered into the system is applied to the various fields in the compliance documents and then is saved into the MySQL database using a proprietary php code and the compliance documents are then converted from HTML and exported to PDF for the user.

23. The method according to claim 19, wherein the method further comprises:
populating annual legal notices based on the information received for creating the booklet wherein the data entered into the system is applied to the various fields in the legal notices and then is saved into the MySQL database using a proprietary php code wherein the legal notices are then converted from HTML and exported to PDF for the user.

24. The method according to claim 19, wherein the method further comprises:
creating a copy of the saved booklet; permitting editing of the copy of the booklet; and storing the edited copy of the booklet as a new booklet, wherein the user will not have to start from scratch if they have a lot of similar information to enter and wherein the booklet is copied and stored via the MySQL database

25. The method according to claim 19, wherein the method further comprises:
translating the saved booklet to another language and once a user has completed their booklet, they can select the Spanish translation feature which sends the English HTML data via a RESTful API to a separate server that houses Lingvanex translation software, and then is returned as Spanish HTML text which is subsequently processed into a PDF link.

26. The method according to claim 19, wherein the method further comprises:
creating a flip booklet from the saved booklet, wherein a user selects the flip booklet option, the completed booklet data is sent to a 3^{rd} party javascript vendor who processes it and returns it as a digital flip booklet which a user can send via the URL made available.

27. The method according to claim 19, wherein the method further comprises:
populating an election sheet based on the information received for creating the booklet, wherein the election sheet comprises selected plans and rates, payroll deduction amounts and boxes to make elections wherein this is a dynamic document that changes as users add or remove various components of their booklet in the system, wherein this feature is made possible by proprietary code in the HTML format and then the HTML format is converted into a PDF for the user.

28. The method according to claim 19, wherein the method further comprises:
populating a premium breakdown sheet based on the information received for creating the booklet wherein this is a dynamic document that provides users with an aggregate summary of all the data calculated in the fifth screen wherein the document changes as users add or remove various components of their booklet in the system wherein this feature is made possible by proprietary code in the HTML format and then the HTML format is converted into a PDF for the user.

29. The method according to claim 19, wherein the Page section in the second screen comprise Insurance Terms and Definitions; Important Items to Remember, Notes, Table of Contents, Page Numbers, Health Savings Account (HSA), Health Reimbursement Arrangements (HRA), Commuter flexible saving account, Flexible Spending Account (FSA), Election sheet, Contact sheet, Contact Sheet 2, Wellness Program and Combined Rate Page, wherein each of these pages is a separate template that is stored in the MySQL database and are available options for a user to select when choosing the options to include in their booklet.

30. The method according to claim 19, wherein the legal notices comprise Chip Notice, Combined Legal Notices, Wellness program disclosure, cobra notice, grandfathered health plan notice, health insurance marketplace notice, Wellness notice, HIPAA notice, RX Medicare creditable coverage disclosure, RX Medicare not creditable coverage disclosure, COVID notice, Gina act, HIPAA Notice and Michelle's law wherein each of these notices is a separate template that is stored in the MySQL database model and are available options for a user to select when choosing the options to include in their booklet.

31. The method according to claim 19, wherein the method further comprises: upon creating the booklet, selecting a color scheme, wherein selection of the color scheme can be made through sets of labelled colors that apply to various parts of the booklets and documents are saved in the MySQL database and users can click on a specific color set and can enter various color codes to select a specific color from the available spectrum wherein these palettes are made possible via HTML elements and the schemes are then saved via the MySQL database.

32. The method according to claim 19, wherein the method further comprises: creating the PDF library; and adding a plurality of PDF files in the PDF library, wherein the plurality of PDF files are arranged in folders and sub-folders, wherein the system is configured to permit adding one or more PDF files of the plurality of PDF files from the library to the booklet using the drag and drop functionality wherein these PDF's are saved in a server folder and the name of the pdf, in association with the user's pdf library, is then stored in the MySQL database model and wherein the user, based on permissions, may be able to share this library with other users for convenience and this is made possible by special permissions granted through the MySQL database model.

33. The method according to claim 19, wherein the method further comprises: receiving annual pay periods, rate type, and contribution type; processing the received annual pay periods, rate type, and contribution type; and present employer's monthly contribution, payroll deduction amount for an employee, and continuation rates wherein these calculations are created via functions on the backend of the system that are housed in a Javascript file wherein the subsequent calculations are then pushed via HTML to the booklet, election sheet and premium breakdown sheet and saved in the MySQL database model via php code.

34. The method according to claim 19, wherein the method further comprises; utilizing downloadable excel sheets to mass populate information in the system wherein users can download pre-set excel templates from the system that are stored in the MySQL database model and allow users to upload multiple companies, plans, pages and rates into the system all at once when users populate the data and re-upload them into the system, the backend of the system fetches the data according to the fields populated and stores the new data into the MySQL database model for a user's future use.

35. The method according to claim 19, wherein the method further comprises; utilizing pre-loaded images or a user's own images to customize their booklets stored in an external third-party storage database, wherein the system saves a URL of these saved images in the internal MySQL database model to be used when a user selects this image for their booklet.
